(19) United States
(12) Patent Application Publication
(10) Pub. No.: US 2015/0159766 A1
(43) Pub. Date: Jun. 11, 2015

(54) MECHANISM FOR AUTOMATIC AIR ELIMINATOR

(71) Applicant: Gammon Technical Products, Inc., Manasquan, NJ (US)

(72) Inventor: James H. Gammon, Manasquan, NJ (US)

(21) Appl. No.: 14/562,822

(22) Filed: Dec. 8, 2014

Related U.S. Application Data
(60) Provisional application No. 61/913,556, filed on Dec. 9, 2013.

(51) Int. Cl. F16K 24/04

(52) U.S. Cl. CPC F16K 24/042

(57) ABSTRACT

An automatic air eliminator for a fluid system is disclosed. The automatic air eliminator includes a body having an interior cavity, a first end, and a second end. A cover is disposed over one of the ends of the body. A seat disposed adjacent the cover includes an orifice in communication with the interior cavity of the body. A primary pivot point is disposed within interior cavity. A first end of a primary arm is pivotally connected to the primary pivot point. A second end of the primary arm is connected to a float. A first end of a secondary arm is pivotally attached to a secondary pivot point on the primary arm. A fulcrum and a sealing element are disposed on an upper surface of the second end of the secondary arm.

### CROSS REFERENCE DATA

The present patent application claims priority to U.S. provisional patent application No. 61/913,556 filed Dec. 9, 2013, hereby incorporated herein by reference in its entirety.

### FIELD OF THE INVENTION

The invention relates to an automatic air eliminator for a fluid system, and more particularly to a valve mechanism for an automatic air eliminator utilizing a compound lever.

### BACKGROUND

Air eliminators, also called air release valves, are commonly employed in closed-loop fluid systems to remove undesirable air pockets from within the fluid system.

One benefit of using air eliminators is an improved efficiency of fluid flow through the system. As air is introduced into a system, it may become trapped in bends, tees, and other fittings in the system. Trapped air within these areas reduces the overall fluid flow of the system by restricting the available cross-section through which fluid may pass. In some cases, trapped air may accumulate within the system to the point that the system becomes “air locked”, and fluid flow is completely blocked.

An additional benefit of using air eliminators is the reduction of required maintenance. For example, trapped air may cause oxidation of system components, not only causing failures, but potentially contaminating the system with oxidized material. Trapped air may also cause what is known as “hammering”, which occurs when an air pocket expands to the extent that it is released. When the air is released, pressurized fluid rushes into the newly created void, creating a hammering effect within the system. Hammering increases stresses within the system and may fatigue the system over time, causing failures.

Air eliminators are generally installed at a high point of the fluid system, wherein an inlet in the air eliminator is in communication with the fluid system. Air entrained within the fluid system is collected by the air eliminator as a system fluid passes the inlet. As air is collected within the air eliminator, system fluid within the air eliminator is forced back into the fluid system, causing the fluid level within the air eliminator to descend. When the fluid level descends, the buoyant force on the float is overcome by the weight of the float, causing the float to descend and open the release valve, thereby releasing the collected air from the air eliminator. As the air is released, system fluid refills the air eliminator and the float ascends, closing the release valve. This process is repeated as additional air from the system is collected within the air eliminator.

Release valves in air eliminators typically employ a sealing element such as a plunger or a stopcock, wherein the sealing element abuts an orifice to prevent the release of air, and is lifted from the orifice to allow the release of air. The force required to unseat the sealing element from the orifice is a function of the differential between the positive pressure on the inside of the air eliminator and the lower atmospheric pressure in the orifice, multiplied by the area of the orifice. Thus, the larger the orifice, the more force that will be required to unseat the sealing element therefrom. This relation places a restriction on air eliminator design, as the size of the orifice must be limited to minimize the unseating force, thereby restricting the flow rate of air from the housing.

To mitigate the restriction on orifice size, some air eliminators utilize a cantilever design to maximize the unseating force applied by the float. In a single-lever configuration, the float is attached to a first end of a pivoting arm within the housing, a second end of the arm is pivotally attached to the housing, and a sealing element is disposed intermediate the first end and the second end. As the float ascends within the housing, the sealing element is lifted and seats against the orifice. When the air eliminator fills with air, the fluid level drops and the weight of the float is leveraged to unseat the sealing element from the orifice. In a single-lever configuration, the force applied by the float to unseat the sealing element is a function of the weight of the float and the distance between the sealing element and the float. Thus, the only way to increase the force applied by the float to the sealing element is to either increase the weight of the float, or to increase the length of the arm. Neither of these options are desirable, as increasing the weight of the float reduces the buoyancy of the float, and increasing the length of the arm requires an increase in the size of the air eliminator housing.

To overcome the shortcomings of single-lever air eliminators, compound levers have been employed within air eliminators. By using a compound lever, an increased force can be applied to the sealing element without increasing the weight of the float or the length of the arm. However, while existing compound-lever air eliminators do provide an increase in flow capacity over single-lever air eliminators, they are still burdened with limitations.

The primary limitation on existing compound-lever air eliminators is that the unseating of the sealing element from the orifice requires a force sufficient to overcome the entire area of the orifice at once. This shortcoming is the consequence of existing compound-lever air eliminators requiring the sealing element to be lifted directly from the orifice.

Another drawback of existing compound-lever air eliminators is a reduced range of motion due to the multiple fixed pivot points. Once the sealing element is unseated from the orifice, it is able to move only a short distance, and remains near the orifice, thereby obstructing the flow of air to the orifice.

Yet another drawback of existing compound-lever air eliminators is increased complexity. Existing compound-lever air eliminators include at least a first lever pivotally fixed to the housing, a second lever pivotally fixed to the housing, and a link pivotally attached to both the first and second levers. Among these three components, there may be at least four distinct pivot points. Along with increased manufacturing costs, this added complexity provides increased potential for failure of the release valve.

Yet another current limitation of both single-lever and compound-lever air eliminators is that they are susceptible to impurities collecting around the orifice, thereby reducing seal contact. Because both single-lever and compound-lever air eliminators lift the scaling mechanism directly from the orifice, impurities that collect around the orifice may become impressed between the sealing element and the orifice as the valve is opened and closed.

It is therefore considered desirable to produce a simplified mechanism for an automatic air eliminator that requires minimal force to unseat a sealing element from an orifice, removes debris from the sealing element, and provides unobstructed flow to the orifice.

### SUMMARY OF THE INVENTION

In concordance with the instant disclosure, a simplified automatic air eliminator that requires minimal force to unseat a sealing element from an orifice, removes debris from the sealing element, and provides unobstructed flow to the orifice, is surprisingly discovered.

In one embodiment, the automatic air eliminator is positionable in a first position, a second position, and an intermediate position. The automatic air eliminator comprises a housing having a first end and a second end. A valve mechanism is disposed adjacent the first end of the housing and includes an orifice for providing fluid communication between an interior chamber of the housing and an atmosphere. The valve mechanism further includes a primary pivot disposed within the housing, a primary arm pivotally attached to the primary pivot, a secondary pivot disposed on the primary arm, a secondary arm pivotally attached to the secondary pivot, and a float depending from the second end of the primary arm. An inlet is disposed on the housing and provides fluid communication between a fluid system and the interior chamber of the housing.

In another embodiment, the invention is a valve mechanism for an automatic air eliminator, positionable in a first position, a second position, and an intermediate positon. The valve mechanism comprises a seat having an orifice formed therethrough, a primary pivot, a primary arm having opposing first and second ends, a secondary arm having opposing first and second ends, a fulcrum, a sealing element, and a float. The first end of primary arm is pivotally attached to the primary pivot, and the first end of the secondary aim is pivotally attached to the primary arm. The fulcrum is disposed adjacent to the second end of the secondary arm. The sealing element disposed on the secondary arm, intermediate the secondary pivot and the fulcrum. The float depends from the second end of the primary aim.

In yet another embodiment, a method of releasing air from a fluid system includes providing an automatic air eliminator comprising a housing having a first end and a second end, a valve mechanism disposed adjacent the first end of the housing, and an inlet disposed on the housing. The inlet is in fluid communication with the fluid system. The valve mechanism includes an orifice for providing fluid communication between an interior chamber of the housing and an atmosphere, a primary pivot disposed within the housing, a primary arm pivotally attached to the primary pivot, a secondary pivot disposed on the primary arm, a secondary arm pivotally attached to the secondary pivot, and a float depending from the primary arm. The method further includes moving the valve mechanism to a first position, wherein the valve mechanism sealingly closes the orifice, moving the valve mechanism to an intermediate position, wherein an edge of the sealing element is peeled away from orifice and the orifice is partially exposed to the interior chamber, and moving the valve mechanism to a second position, wherein the sealing member is fully unseated from the orifice and the orifice is fully exposed.

### BRIEF DESCRIPTION OF THE DRAWINGS

FIG. 1 is a schematic cross-sectional front elevational view of an automatic air eliminator according to the instant disclosure, where the valve mechanism is in a first position.

FIG. 2 is a cross-sectional schematic front elevational view of the automatic air eliminator of FIG. 1, where the valve mechanism is in an intermediate position.

FIG. 3 is a cross-sectional schematic front elevational view of the automatic air eliminator of FIG. 1, where the valve mechanism is in a second position.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

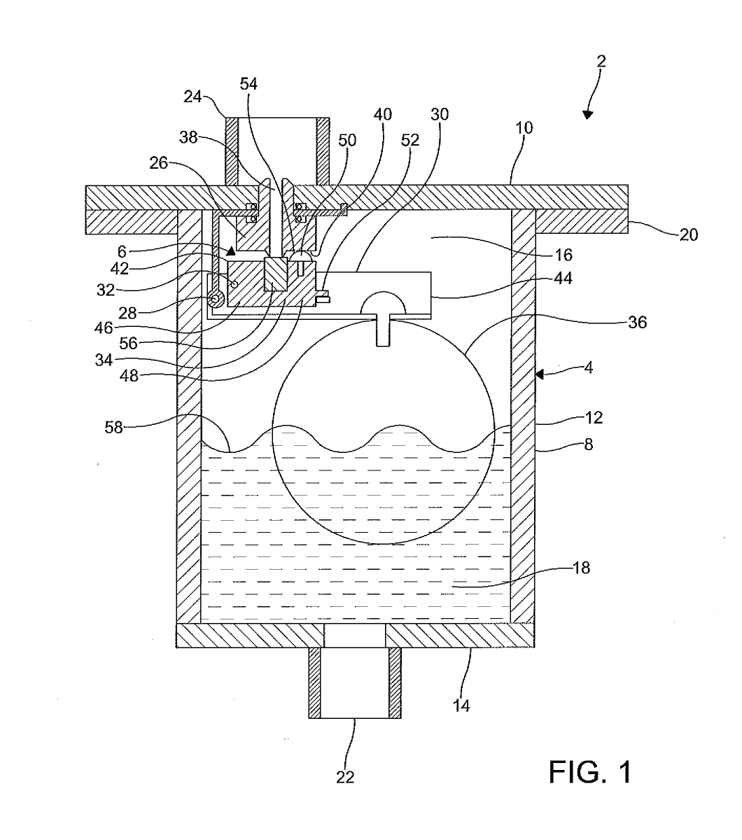

FIGS. 1-3 illustrate an automatic air eliminator 2 according to an embodiment of the present invention. As shown, the automatic air eliminator 2 includes a housing 4 and a valve mechanism 6.

The housing 4 includes a main body 8 and a cover 10. The main body 8 includes a central portion 12, an enclosed first end 14, and an open second end 16 that form a hollow interior cavity 18. The exemplary main body 8 includes a mounting surface 20 disposed adjacent the open second end 16.

A housing inlet 22 is provided at the enclosed first end 14 of the main body 8 and provides fluid communication between a fluid source (not shown) and the interior cavity 18. In another embodiment, the housing inlet 22 may be provided at the central portion 12 of the main body 8. As shown, the housing inlet 22 is formed separate from the main body 8. In yet another embodiment, the housing inlet 22 may be formed integral with the main body 8. The housing inlet 22 may incorporate a filtration means or a metering means.

The cover 10 abuts the mounting surface 20 of the main body 8 and encloses the interior cavity 18. An outlet 24 is provided on an outer surface of the cover 10, and provides fluid communication between the interior cavity 18 and an exterior atmosphere.

The valve mechanism 6 is disposed within the housing 4, and includes a seat 26, a primary pivot 28, a primary arm 30, a secondary pivot 32, a secondary arm 34, and a float 36.

The seat 26 is coupled to an interior face of the cover 10. In the embodiment shown, the scat 26 includes an orifice 38 formed therethrough and a seating surface 40 exposed to the interior cavity 18. A portion of the seat 26 including the orifice 38 extends through the thickness of the cover 10, wherein the orifice 38 provides fluid communication between the interior cavity 18 and the outlet 24. The orifice 38 of the instant disclosure has a substantially circular cross-sectional shape, but may have other cross sectional shapes, such as ellipsoidal or polygonal, for example.

The primary pivot 28 is disposed within the interior cavity 18. In the exemplary embodiment, the primary pivot 28 depends from an interior face of the cover 10 and is disposed beneath the seat 26 and adjacent a wall of the central portion 12.

The primary aim 30 includes a first end 42 and an opposing second end 44. The first end 42 of the primary arm 30 is pivotally attached to the primary pivot 28. The second end 44 of the primary arm 30 extends laterally inwardly from the primary pivot 28. The primary arm 30 further includes the secondary pivot 32 disposed intermediate the first end 42 and the second end 44 thereof.

The float 36 depends from the second end 44 of the primary arm 30. As illustrated, an upper portion of the float 36 is directly coupled to the primary arm 30, but the float 36 may also be suspended from the primary arm 30 by an intermediate suspension member or a clevis, for example. The float 36 shown is a hollow body having an outer shell constructed of a metallic or polymeric material. The float 36 may also be a solid body constructed of a buoyant material, such as polystyrene or wood.

The secondary arm 34 includes a first end 46 and a second end 48. The first end 46 of the secondary aim 34 is pivotally coupled to the secondary pivot 32 of the primary arm 30. A fulcrum 50 is disposed on an upper surface of the secondary arm 34 adjacent the second end 48. The fulcrum 50 includes a contact surface 54. The contact surface 54 may have a radiused shape, such as a hemisphere or a semi-cylinder, for example. A sealing element 56 extends from an upper surface of the secondary arm 34, intermediate the secondary attachment point and the fulcrum 50.

A positive stop 52 includes a pair of tabs formed on the primary arm 30 and the secondary arm 34, respectively. When the positive stop 52 is engaged, the tab of the secondary aim 34 abuts the tab of the primary arm 30, and rotation of the secondary arm 34 relative to the primary aim 30 is limited. While one embodiment of a positive stop 52 is illustrated, the positive stop 52 may be of any configuration capable of limiting rotation of the secondary arm 34. For example, the positive stop 52 may be integral to the secondary pivot 32, such as a key and keyway, for example.

The valve mechanism 6 is positionable in a first position, a second position, and an intermediate position, wherein the sealing element 56 sealingly closes the orifice 38 when in the first position, fully exposes the orifice 38 when in the second position, and partially exposes the orifice 38 when in the intermediate position, as shown in FIGS. 1, 2, and 3.

FIG. 1 illustrates the automatic air eliminator 2 according to the instant disclosure where the valve mechanism 6 is in the first position. A system fluid 58 is present in the interior cavity 18 at a first level. The float 36, being buoyant in the system fluid 58, is forced upward and retains the valve mechanism 6 in the first position.

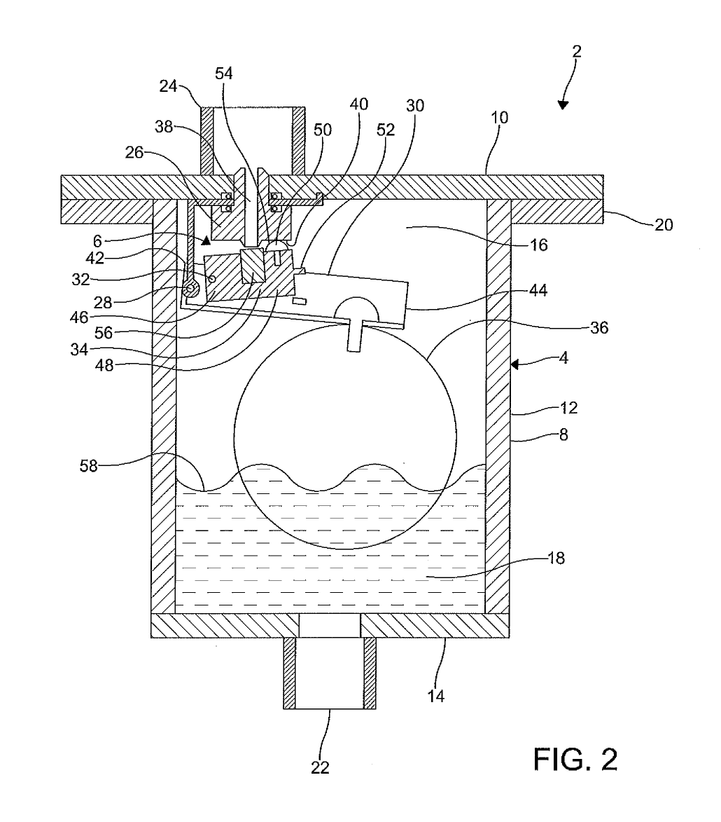

As air is introduced into the interior cavity 18 through the housing inlet 22, the system fluid 58 descends to a second level as shown in FIG. 2. A pressure force on the sealing element 56 created by a pressure differential between the positive pressure within the interior cavity 18, and an atmospheric pressure in the orifice 38, prevents the sealing element 56 from being unseated from the orifice 38. As the system fluid 58 descends, the weight of the float 36 is leveraged against the fulcrum 50 through the secondary pivot 32, and the valve mechanism 6 moves to an intermediate position, wherein an edge of the sealing element 56 nearest the first end 46 is lifted away from the orifice 38 to partially expose the orifice 38 to the interior cavity 18. The positive pressure within the interior cavity 18 is released through the partially exposed orifice 38, thereby reducing the pressure differential between the interior cavity 18 and the orifice 38.

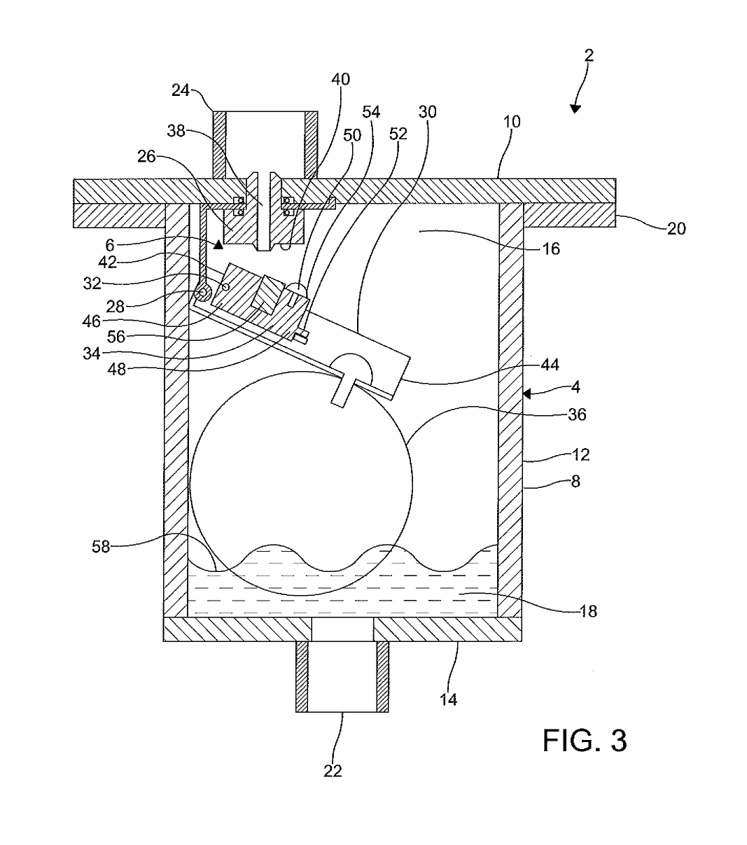

As the pressure differential between the interior cavity 18 and the orifice 38 becomes sufficiently equalized, the valve mechanism 6 moves to the second position wherein the sealing element 56 is fully unseated to allow maximum flow of air through the orifice 38, as shown in FIG. 3. In the second position, the fulcrum 50 moves away from the seating surface 40, the secondary arm 34 returns to the first position against the positive stop 52, and the float 36 descends to the second position.

As air is released, the pressure within the interior cavity 18 is reduced and the system fluid 58 returns to the interior cavity 18 to replace the released air. The ascending system fluid 58 urges the second end 44 of the primary arm 30 upward, wherein the positive stop 52 engages to force the second end 48 of the secondary arm 34 upward. The fulcrum 50 then contacts the seating surface 40, and the sealing element 56 sealingly closes the orifice 38, thereby preventing fluid communication between the interior cavity 18 and the orifice 38.

By employing the disclosed embodiment, a larger orifice 38 may be used than in prior automatic air eliminators. For example, an automatic air eliminator employing a single lever may have a 2.5 ounce float mounted on a lever that provides a 4:1 mechanical advantage over the sealing element, generating 10 ounces of downward force on the sealing element to overcome the vacuum force of the orifice. If the pressure within the interior cavity measures 150 psi, then the orifice could only have a cross-sectional area of 0.0041 square inches if the downward force applied by the weight of the float is to overcome the vacuum force.

Using the disclosed embodiment, the available downward force on the sealing element 56 can be at least doubled over automatic air eliminators of the prior art, without the need to increase the size of the housing 4 or the weight of the float 36. For example, the float 36 attached to the primary arm 30 of the same length as the lever in a single lever air eliminator has a 4:1 advantage over the secondary pivot 32. The secondary pivot 32, in turn, provides a 2:1 advantage over the sealing element 56, totaling an 8:1 advantage of the float 36 over the sealing element 56, and allowing the cross-sectional area, and consequently, the flow capacity of the orifice 38 to be doubled in comparison to the orifice of the single lever design.

Additionally, the use of the radiused fulcrum 50 provides the advantageous progressive motion of the sealing element 56 from the orifice 38, wherein the edge of the sealing element 56 nearest the first end 46 is lifted away from the orifice 38 to partially expose the orifice 38 to the interior cavity 18. This progressive motion allows for a reduced unseating force compared to the lifting motion used by conventional compound-lever air eliminators, as the valve mechanism 6 must only overcome a fraction of the differential pressure force to break the sealing element 56 away from the orifice 38. Surprisingly, it has been discovered that by utilizing the progressive motion, the cross-sectional area of the orifice 38 can be tripled compared to orifices of conventional compound-lever air eliminators.

Additionally, the fulcrum 50 is able to move laterally along the seating surface 40, creating a wiping effect between the sealing element 56 and the orifice 38, wherein debris that may collect on the sealing element 56 is wiped away to maintain the sealing capability.

Furthermore, the design of the instant disclosure provides improved manufacturability and reduced failure potential. By connecting the secondary attachment point 70 directly to the primary pivot 28 on the primary arm 30, no intermediate link is needed between the primary arm 30 and the secondary arm 34, eliminating one additional part and pivot. The use of the fulcrum 50 in combination with the positive stop 52 holds the second end 48 of the secondary arm 34 in the first position, eliminating the need for a fixed pivot at the second end 48 of the secondary arm 34.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An automatic air eliminator, comprising:
a housing having a first end and a second end;
a valve mechanism disposed within and adjacent the first end of the housing, the valve mechanism including an orifice providing fluid communication between an interior chamber of the housing and an atmosphere, a primary pivot, a primary arm pivotally coupled to the primary pivot, a secondary arm pivotally coupled to the primary arm at a secondary pivot, and a float depending from the primary arm; and
an inlet formed in the housing, the inlet providing fluid communication between a fluid system and the interior chamber of the housing.

2. The automatic air eliminator of claim 1, wherein the secondary arm further comprises a fulcrum disposed thereon.

3. The automatic air eliminator of claim 2, wherein the secondary arm further comprises a sealing element disposed thereon.

4. The automatic air eliminator of claim 3, wherein the secondary aim further comprises a first end and an opposing second end, the fulcrum disposed adjacent the second end on an upper surface of the secondary arm, and the sealing element extends from the upper surface intermediate the fulcrum and the secondary pivot.

5. The automatic air eliminator of claim 3, wherein in a first position the sealing element fully seals the orifice, in a second position the sealing element is fully unseated and the orifice is unsealed, and in an intermediate position the orifice is partially exposed.

6. The automatic air eliminator of claim 3, the valve mechanism further comprising a seating surface, wherein a contact surface of the fulcrum contacts the seating surface when the valve mechanism is in the first position and in the intermediate position, and the fulcrum does not contact the seating surface when the valve mechanism is in the second position.

7. The automatic air eliminator of claim 6, wherein the contact surface of the fulcrum is radiused.

8. The automatic air eliminator of claim 1, wherein the valve mechanism further comprises a seat, the orifice being formed through the seat.

9. The automatic air eliminator of claim 1, wherein the valve mechanism further comprises a positive stop configured to limit a relative motion between the primary arm and the secondary arm.

10. The automatic air eliminator of claim 9, wherein the positive stop further comprises a pair of tabs, one of the pair of tabs respectively disposed on each of the primary arm and the secondary arm.

11. The automatic air eliminator of Claim I, wherein the inlet is formed in the second end of the housing.

12. A valve mechanism for an automatic air eliminator comprising:
a seat having an orifice formed therethrough;
a primary pivot;
a primary arm having a first end and an opposing second end, the first end of primary arm pivotally coupled to the primary pivot;
a secondary arm having a first end and an opposing second end, the first end of the secondary arm pivotally coupled to the primary arm;
a fulcrum disposed adjacent the second end of the secondary arm;
a sealing element disposed on the secondary arm; and
a float depending from the second end of the primary arm.

13. The valve mechanism of claim 12, wherein the primary arm includes a secondary pivot disposed adjacent a first end thereof, the secondary arm pivotally coupled to the secondary pivot.

14. The valve mechanism of claim 13, wherein the sealing element is disposed intermediate the fulcrum and the secondary pivot.

15. The valve mechanism of claim 12, wherein the fulcrum is disposed on an upper surface of the secondary arm, and the sealing element extends from the second surface of the secondary arm.

16. The valve mechanism of claim 12, wherein the fulcrum includes a radiused contact surface.

17. The valve mechanism of claim 16, the seat further comprising a seating surface, wherein a contact surface of the fulcrum contacts the seating surface when the valve mechanism is in a first position and an intermediate position, and the fulcrum does not contact the seating surface when the valve mechanism is in a second position.

18. The valve mechanism of claim 12, wherein in a first position the sealing element sealingly closes the orifice, in a second position the sealing element fully exposes the orifice, and in an intermediate position the sealing element partially exposes the orifice.

19. The automatic air eliminator of claim 12, wherein the valve mechanism further comprises a positive stop configured to limit a relative motion between the primary arm and the secondary arm.

20. A method of releasing air from a fluid system, comprising the steps of:
providing an automatic air eliminator comprising,
a housing having a first end and a second end,
a valve mechanism disposed adjacent the first end of the housing, the valve mechanism including an orifice providing fluid communication between an interior chamber of the housing and an atmosphere, a primary pivot disposed within the housing, a primary arm pivotally coupled to the primary pivot, a secondary arm pivotally coupled to the primary arm, and a float depending from the primary arm, and
an inlet disposed on the housing, the inlet in fluid communication with the fluid system;
moving the valve mechanism to a first position, wherein the valve mechanism sealingly closes the orifice;
moving the valve mechanism to an intermediate position, wherein the orifice is partially exposed to the interior chamber;
moving the valve mechanism to a second position, wherein the orifice is fully exposed.
